(19) United States
(12) Patent Application Publication
(10) Pub. No.: US 2023/0396855 A1
(43) Pub. Date: Dec. 7, 2023

(54) DISPLAY DEVICE

(71) Applicant: Funai Electric Co., Ltd., Osaka (JP)

(72) Inventors: Masanori MATSUMOTO, Osaka (JP); Yuya NAKAMURA, Osaka (JP)

(21) Appl. No.: 18/328,858

(22) Filed: Jun. 5, 2023

(30) Foreign Application Priority Data
Jun. 6, 2022 (JP) 2022-91387

(51) Int. Cl. H04N 21/647; H04N 21/2343; H04N 21/431; H04N 21/258; H04N 21/439

(52) U.S. Cl. CPC H04N 21/64746; H04N 21/2343; H04N 21/431; H04N 21/258; H04N 21/439; H04N 21/42222

(57) ABSTRACT

A display device comprises a display configured to display video, a controller configured to control image quality adjustment of the video displayed on the display, and a user interface configured to receive user input related to image quality of the video, the controller being configured to decide on, from among a plurality of image quality adjustment categories, at least one image quality adjustment category related to user input content, on the basis of user input operation related to the image quality of the video to the user interface, and to display, on the display, an operation screen for the at least one image quality adjustment category so as to perform an image quality adjustment operation for the at least one image quality adjustment category.

### CROSS-REFERENCE TO RELATED APPLICATIONS

This application claims priority to Japanese Patent Application No. 2022-91387 filed in Japan on Jun. 6, 2022. The entire disclosure of Japanese Patent Application No. 2022-91387 is hereby incorporated herein by reference.

### BACKGROUND

### Field of the Invention

The present invention generally relates to a display device. More specifically, the present invention relates to a display device that controls image quality adjustment of video.

### Background Information

There are conventional display devices that control the image quality adjustment of video (see Japanese Laid-Open Patent Application Publication No. 2001-268475 (Patent Literature 1), for example).

The above-mentioned Patent Literature 1 discloses an image quality adjustment device (display device) comprising a splitting control unit that splits a display screen into an original area and an adjustment area and outputs an area identification signal, and an image quality adjustment unit that identifies an image portion of an original image from the area identification signal, and processes and outputs an original image signal so that image quality adjustment processing is performed only on the image signal of the portion displayed in the adjustment area of the original image. With this image quality adjustment device, the display screen is split into a left area and a right area, and the left part of the original image is displayed in the left area, and an image of the state when the right part of the original image has undergone quality adjustment is displayed as an adjusted image in the right area. In this state, the configuration is such that the user can set the optimal adjustment state by changing the image quality adjustment category, such as average brightness, contrast, and sharpness, and the direction and degree of this adjustment.

### SUMMARY

With the image quality adjustment device described in Patent Literature 1, it is necessary for the user to individually adjust image quality adjustment categories, such as average brightness, contrast, and sharpness. A typical user will be unfamiliar with many of these image quality adjustment categories. In the above-mentioned image quality adjustment device, a plurality of image quality adjustment categories are prepared. Therefore, it may be difficult for a typical user to appropriately select an image quality adjustment category for changing to the image quality to the image quality desired by the user from among a plurality of image quality adjustment categories, and adjust the image quality to the desired image quality. Accordingly, a problem is that for a user who cannot accurately recognize what kind of change in image quality will result from adjustment to a given adjustment category and to what extent the adjustment will be, it may be difficult to control the image quality adjustment to match the user's intention.

One object of the present disclosure is to provide a display device with which the image quality can be easily adjusted as intended by the user.

In view of the state of the known technology, a display device according to one aspect of the present disclosure comprises a display that displays video, a controller that controls image quality adjustment of the video displayed on the display, and a user interface that receives user input related to image quality of the video. The controller is configured to decide on, from among a plurality of image quality adjustment categories, at least one image quality adjustment category related to user input content, on the basis of user input operation related to the image quality of the video to the user interface, and to display, on the display, an operation screen for the at least one image quality adjustment category so as to perform an image quality adjustment operation for the at least one image quality adjustment category.

### BRIEF DESCRIPTION OF THE DRAWINGS

FIG. 1 is a block diagram of the overall configuration of a display device according to an embodiment;

FIG. 2 is a diagram of a remote controller in this embodiment;

FIG. 3 is a diagram of a character input screen in this embodiment;

FIG. 4 is a diagram of a voice input screen in this embodiment;

FIG. 5 is a diagram of a video/audio setting screen in this embodiment;

FIG. 6 is a diagram of an image quality setting screen in this embodiment;

FIG. 7 is a diagram of a selection screen for a current image quality state in this embodiment;

FIG. 8 is a diagram of image quality adjustment screen selection in this embodiment;

FIG. 9 is a diagram of a screen on which an image quality adjustment category for the current image quality state has been decided on in this embodiment;

FIG. 10 is a diagram of a detailed setting screen for an image quality adjustment category in this embodiment;

FIG. 11 is a diagram of a batch adjustment screen for image quality adjustment categories in this embodiment;

FIG. 12 is a diagram of an image quality adjustment screen split into four in this embodiment;

FIG. 13 is a diagram of a sound quality setting screen in this embodiment; and

FIG. 14 is a flowchart showing an image quality adjustment method used with the display device in this embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

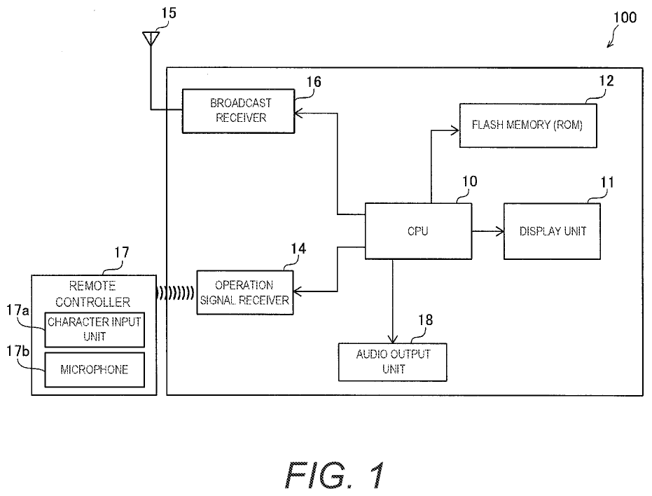

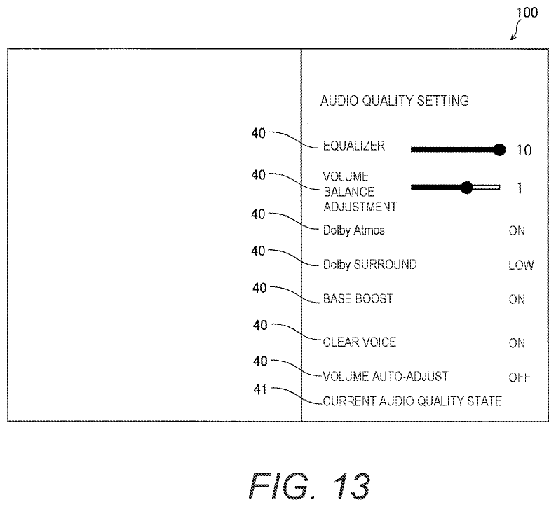

First, the structure of a display device 100 according to this embodiment will be described with reference to FIGS. 1 to 14.

As shown in FIG. 1, the display device 100 is configured such that a display unit 11 (e.g., a display) displays video received by the display device 100 via an antenna 15. A remote controller 17 (e.g., a user interface) that the user can operate comes with the display device 100. The remote controller 17 comprises a character input unit 17a (e.g., a character input interface) and a microphone 17b (e.g., an audio input interface). The remote controller 17 is an example of the “input unit or user interface” of the present disclosure, and the microphone 17b is an example of the “audio input unit or audio input interface” of the present disclosure. Here, the term “interface” as used herein refers to hardware that is the point of interaction between the user and the display device 100.

The display device 100 comprises the display unit 11 that displays video, and a CPU (central processing unit) 10 (e.g., a controller or a processor). The display device 100 also comprises a flash memory (ROM) 12, an operation signal receiver 14, a broadcast receiver 16, and an audio output unit or device 18. The CPU 10 is an example of the “control unit or controller” of the present disclosure.

The display unit 11 includes a display that is configured to display video. The display unit 11 is, for example, liquid crystal cells (a liquid crystal panel). Of course, the display unit 11 is not limited to this, and can be any other type of display, such as an organic electroluminescence panel, etc.

The role of the CPU 10 is to control the overall display device 100 by executing a control program. The CPU 10 is an example of an electronic controller. It will be apparent to those skilled in the art from this disclosure that the precise structure and algorithms can be any combination of hardware and software that will carry out the functions of the present invention. Here, the term “electronic controller” as used herein refers to hardware that executes a software program, and does not include a human.

The flash memory 12 stores control programs and the like to be executed by the CPU 10.

The operation signal receiver 14 has the function of receiving a control signal from the remote controller 17 that comes with the display device 100. The operation signal receiver 14 includes a Bluetooth receiver, an IR receiver (infrared-receiver), etc.

The broadcast receiver 16 consists of, for example, a tuner, an external input such as HDMI (registered trademark), VOD via a network, or the like, and is configured to receive broadcast signals through an antenna 15.

The audio output unit 18 includes a speaker, for example, and is configured to output audio.

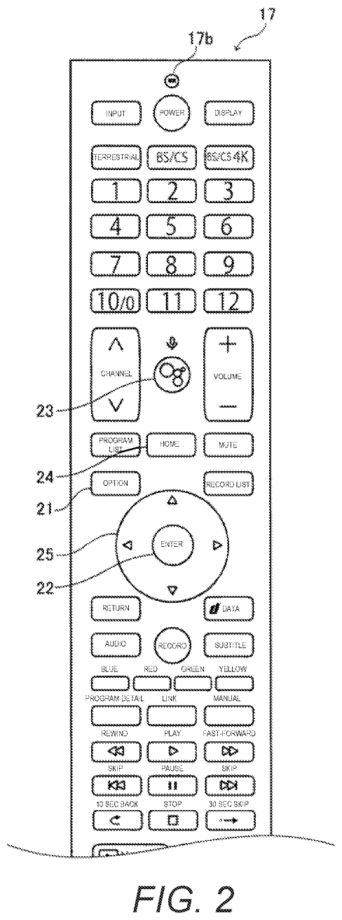

As shown in FIG. 2, the character input unit 17a is the buttons on the remote controller 17, for example. The remote controller 17 includes the microphone 17b, an option button 21, an enter button 22, a pairing button 23, a home button 24, and an arrow button 25, and is configured to allow wireless communication with the display device 100. For instance, it is configured to communicate according to the Bluetooth (registered trademark) standard. Of course, it can be configured to communicate with the display device 100 using an IR transmitter. The microphone 17b is an example of the “audio input unit or audio input interface” of the present disclosure.

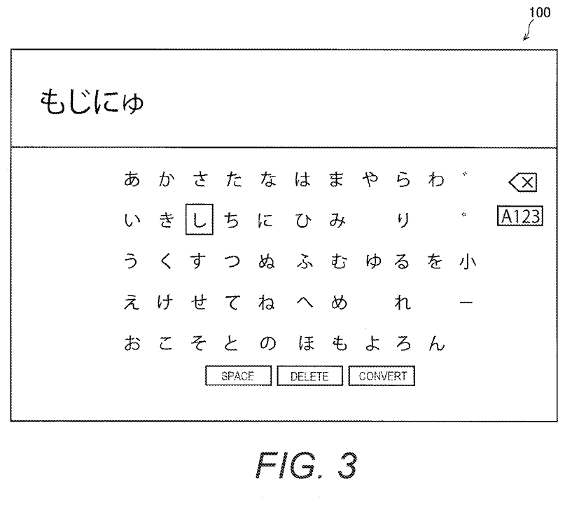

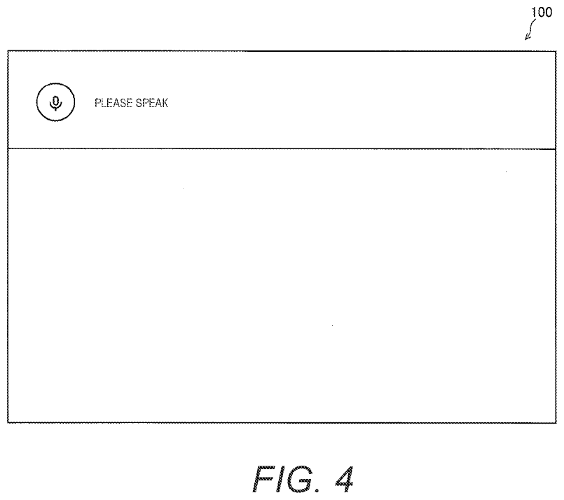

As shown in FIGS. 1 and 3, the remote controller 17 is configured such that user request for image quality of the video indicated by a first input content, or user state indicated by a second input content, can be inputted by text on a character input screen by operation of the remote controller 17. Also, as shown in FIGS. 1 and 4, the microphone 17b of the remote controller 17 can be used to perform audio/voice input of the first input content and the second input content to an audio input screen.

The remote controller 17 includes at least one of the character input unit 17a that receives character input and the microphone 17b that receives audio input to receive the user request for image quality of the video indicated by the first input content, or the user state indicated by the second input content. The user input related to the image quality of the video to the remote controller 17 includes the first input content indicating the user request for improvement of the image quality of the video, or the second input content indicating the user state.

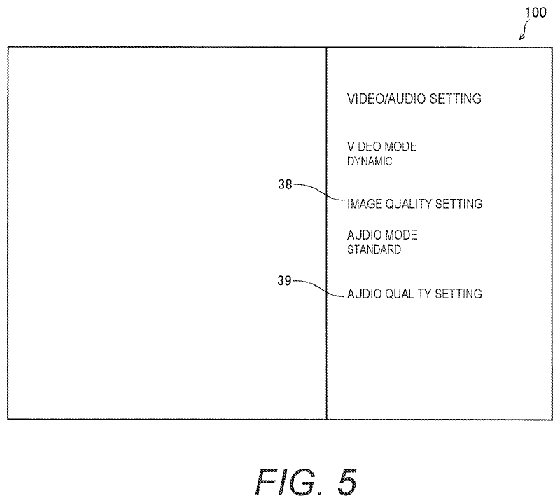

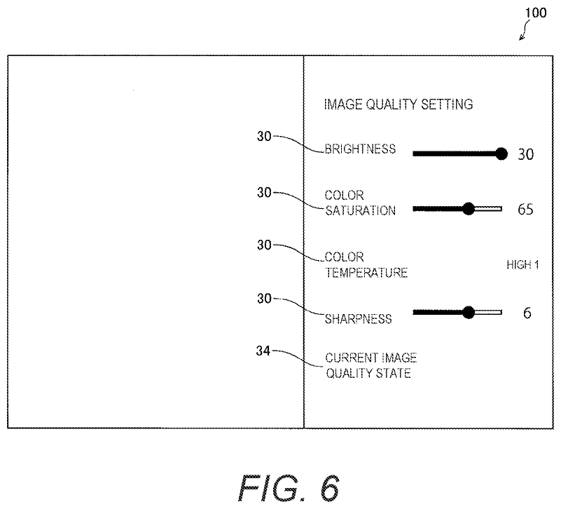

As shown in FIG. 5, the CPU 10 displays, on the display unit 11, a “video/audio setting” screen, which allows the selection of the categories of video mode, image quality setting 38, audio mode, and sound quality setting 39. The CPU 10 is configured such that when these categories are selected, the screen changes to the one corresponding to the selected category. For example, when the image quality setting 38 is selected, the “image quality setting” screen shown in FIG. 6 is displayed.

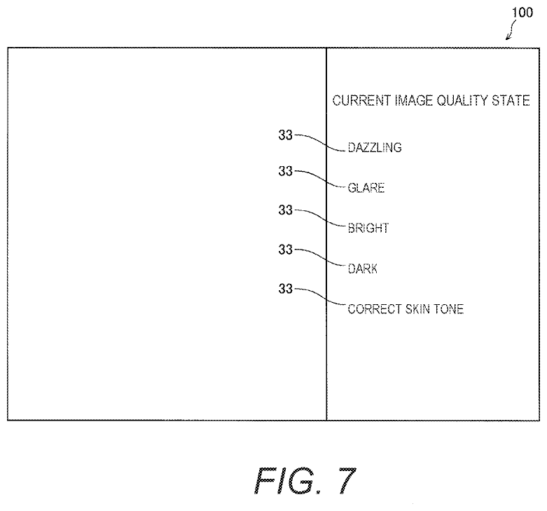

As shown in FIG. 6, on the “image quality setting” screen, the user can select from among brightness, color depth, color temperature, sharpness, and other such image quality adjustment categories 30, and the current image quality state 34. For example, brightness can be adjusted between 0 and 30, color depth between 0 and 100, sharpness between 0 and 10, and color temperature between low, medium, high 1, and high 2. Also, when the current image quality state 34 is selected, the CPU 10 is configured to change the screen display of the display unit 11 to the “current image quality state” screen shown in FIG. 7.

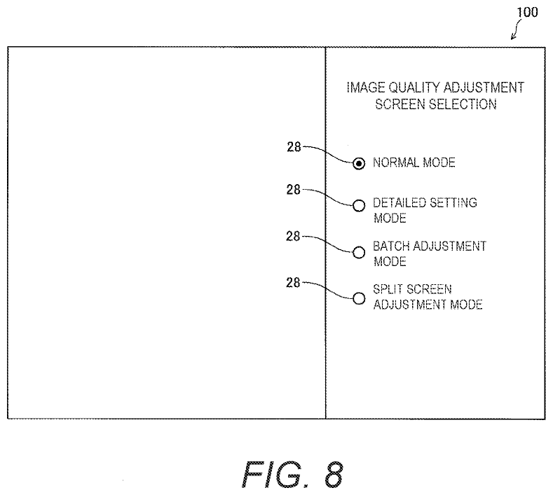

As shown in FIG. 7, on the “current image quality state” screen, the user can select from among options 33 for user request that the user is expected to have for the screen, such as dazzling, glaring, bright, dark, and correction of skin tones. These options 33 are stored in advance in the flash memory 12. When one of the options 33 is selected, the display unit 11 is configured to change to the screen corresponding to the setting content on the basis of the preset setting content “image quality adjustment screen selection (see FIG. 8).” As will be discussed below, the CPU 10 selects and displays at least one image quality adjustment category 32 related to the selected option 33 from among image quality adjustment categories 32, on any screen that is changed to. Individual options 33 and image quality adjustment categories 32 related to these options 33 are stored in advance in the flash memory 12 in a state of being associated with each other.

As shown in FIG. 8, the “image quality adjustment screen selection” screen is configured so that radio buttons 28 for normal mode, detailed setting mode, batch adjustment mode, and split screen mode can be selected. The normal mode is selected in the factory shipping state. When the remote controller 17 is operated, the CPU 10 can directly change to the screen of “image quality adjustment screen selection.” This selection changes what the screen will become when the option 33 of the adjustment category of the “current image quality state” shown in FIG. 7 is selected.

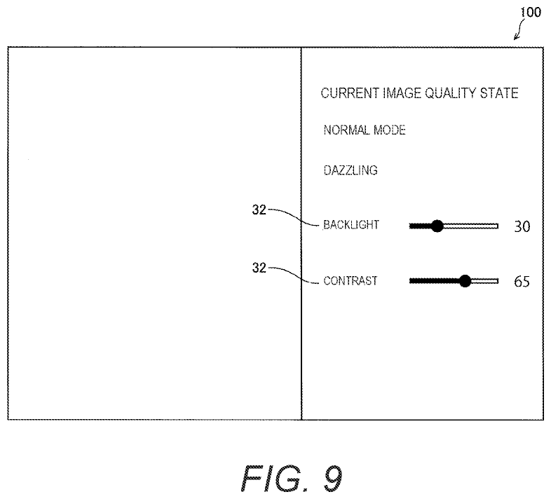

When the normal mode is selected on the “image quality adjustment screen selection” screen (see FIG. 8), the CPU 10 changes the display unit 11 to the “current image quality state (normal mode)” screen in FIG. 9 after the selection of an option 33, which is a category of the “current image quality state” screen, as shown in FIG. 7. On the “current image quality state (normal mode)” screen, the CPU 10 decides on the at least one image quality adjustment category 32 related to the option 33 stored in the flash memory 12 based on the selection of the option 33 corresponding to user request, as shown in FIG. 7. Also, the image quality adjustment category 32 can be selected and adjusted on the “current image quality state (normal mode)” screen in FIG. 9.

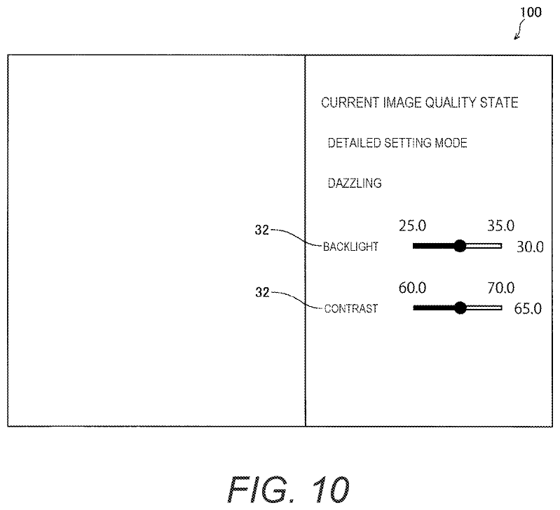

When the detailed setting mode is selected on the “image quality adjustment screen selection” screen (see FIG. 8), the CPU 10 changes the screen display of the display unit 11 to the “current image quality state (detailed setting mode)” screen as shown in FIG. 10 after the selection of an option 33, which is a category of the “current image quality state” screen (see FIG. 7). The CPU 10 is configured to store the image quality adjustment values when the user adjusts the image quality, in the flash memory 12 as adjustment history. In the “current image quality state (detailed setting mode),” the CPU 10 is configured to change so that more precise image quality adjustment than with a preset adjustment range can be performed by reducing an adjustment unit of an adjustment range of an adjustment amount on the basis of the user adjustment history of the image quality adjustment category 32 in the image quality adjustment. The range of each image quality adjustment category is initially set for each category, and adjustments that had been made in the range of integer values can now be adjusted in the range of decimal values. For example, if the adjustment history indicates that an adjustment was made to 65 in a range of 0 to 100, the adjustment range is changed to 60.0 to 70.0. Also, the adjustment range is configured to increase on the basis of the adjustment history in which the maximum value of the adjustment range is selected. For example, if there is an adjustment history of adjusting to 100 in the range of 0 to 100, the adjustment range is changed to 50 to 150. If the user wants to go back to the normal range, a mode other than the detailed setting mode is selected on the “image quality adjustment screen selection” screen.

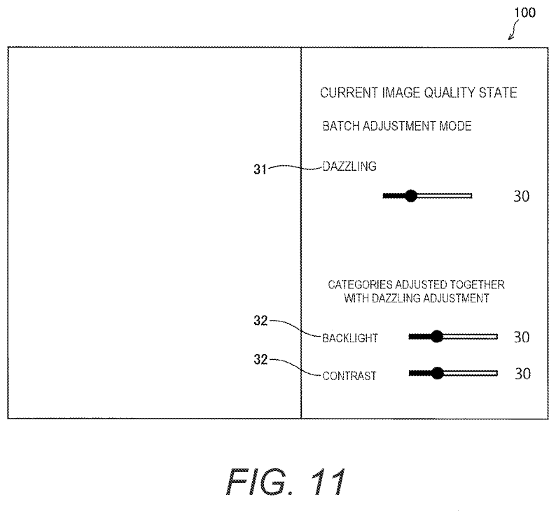

When the batch adjustment mode is selected on the “image quality adjustment screen selection” screen (see FIG. 8), the CPU 10 changes the screen display of the display unit 11 to the “current image quality state (batch adjustment mode)” screen as shown in FIG. 11 after the selection of an option 33, which is a category of the “current image quality state” screen, as shown in FIG. 7. The CPU 10 decides on a plurality of image quality adjustment categories 32 (e.g., a set of the image quality adjustment categories 32) on the basis of the selection of the option 33 that is the category of the “current image quality state” screen, as shown in FIG. 7. Then, the CPU 10 displays, on the display unit 11, one image quality adjustment category 31 that can adjust the decided image quality adjustment categories 32 shown in FIG. 11 together. Consequently, the CPU 10 can adjust the decided image quality adjustment categories 32 together according to the adjustment of the one image quality adjustment category 31 in response to the user adjusting the one image quality adjustment category 31 displayed on the display unit 11. After adjusting the one image quality adjustment category 31, the CPU 10 receives user selection of one of the decided image quality adjustment categories 32. Also, the CPU 10 prohibit adjustment of remainder of the decided image quality adjustment categories 32 other than the selected one of the decided image quality adjustment categories 32 when the selected one of the decided image quality adjustment categories 32 is adjusted. This “prohibition of adjustment of the remainder of the decided image quality adjustment categories 32” refers to prohibition of adjustment of the remainder of the decided image quality categories 32 in conjunction with or at the same time of adjustment of the selected one of the image quality adjustment categories 32 on the basis of the adjustment of the image quality of the selected one of the image quality adjustment categories 32.

When the split screen adjustment mode is selected on the “image quality adjustment screen selection” screen (see FIG. 8), the CPU 10 changes the screen display of the display unit 11 to the “current image quality state (normal mode)” shown in FIG. 9 after the selection of an option 33, which is a category of the “current image quality state” screen, as shown in FIG. 7. Then, when the user selects at least one image quality adjustment category 32, the CPU 10 splits the screen on the display unit 11 according to the number of image quality adjustment categories 32 selected by the user, and displays the result on the “split image quality adjustment screen.” Also, the CPU 10 selectively reflects adjustment state for each of the image quality adjustment categories 32 selected by the user on the corresponding one of split screens of the display unit. More specifically, if the image quality adjustment categories 32 of the “current image quality state (normal mode)” is selected, then the display screen is split into the split screens on the basis of the image quality adjustment categories 32 decided on by the CPU 10. More precisely, when two image quality adjustment categories 32 are decided on, the CPU 10 splits the screen into four on the “image quality adjustment screen.” The screen prior to adjustment is displayed on the upper left screen 35a. Only one of the image quality adjustment categories 32 can be adjusted on the lower left screen 35b. Also, on the upper right screen 35c, only different one of the image quality adjustment categories 32 that is different from the one of the image quality adjustment categories 32 adjustable on the lower left screen 35b can be adjusted. Two of the image quality adjustment categories 32 can be adjusted on the lower right screen 35d. Also, the CPU 10 can perform adjustment by moving a cursor 37 to the image quality adjustment bar 36 according to the operation of the remote controller 17. When the “end adjustment” button is selected, the image quality adjustment is ended and the adjusted image quality is reflected on the display unit 11. Also, when “return” is selected, the screen returns to the “current image quality state (normal mode)” screen shown in FIG. 9, and the option 33 can be selected again.

Also, as shown in FIG. 3, the “character input” screen is configured such that characters can be inputted by putting the user state in words. When the user state is inputted to the character input unit 17a as a phrase or text from the remote controller 17, the CPU 10 decides on an image quality adjustment category 32 that is related to the phrase. Then, the display unit 11 changes to the “current image quality state (normal mode)” screen shown in FIG. 9.

Also, as shown in FIG. 4, the “audio Input” screen is configured such that the user state can be inputted by audio/voice. When the user state is inputted to the microphone 17b by audio/voice, the CPU 10 decides on an image quality adjustment category 32 that is related to the request for image quality. Then, the display unit 11 changes to the “current image quality state (normal mode)” screen shown in FIG. 9.

### Flow of Operation

The flow of a series of operations for image quality adjustment will now be described. The user operates the remote controller 17 to switch the display unit 11 to “video/audio setting” (see FIG. 5). More specifically, the user presses the option button 21 on the remote controller 17. In response, the operation signal receiver 14 receives an operation signal to switch to the “video/audio setting” transmitted from the remote controller 17, and the CPU 10 switches the display screen to the “video/audio setting.” In the following description, “operation of the remote controller 17 by the user” means a user operation of pressing a button on the remote controller 17 to cause the operation signal receiver 14 to receive an operation signal from the remote controller 17, or an operation to perform audio input to the microphone 17b.

When the user selects the image quality setting 38 on the “video/audio setting” screen, the display unit 11 switches to “image quality setting” as shown in FIG. 6. When the user selects the current image quality state 34 from the image quality adjustment categories 30 and the current image quality state 34 that are categories of the “image quality setting”, the options 33 that are categories of the “current image quality state” are displayed on the display unit 11 as shown in FIG. 7.

The options 33 in the categories of the current image quality state 34 simply displays the user state that the user is believed to be feeling with respect to the currently displayed image quality. The options 33 in the categories of the current image quality state 34 are as follows: the screen is too dazzling, the screen has too much glare, the screen is too bright, the screen is too dark, and the skin tone of people on the screen looks unnatural. These are specific things with which the user is dissatisfied (user request for improvement).

In this embodiment, a case in which an option 33 “dazzling” is selected from the categories of “current image quality state” will be described. When “dazzling” is selected, as shown in FIG. 9, the CPU 10 decide on backlight and contrast as categories related to “dazzling.” Related categories are stored in the flash memory 12 in association with keywords. Consequently, the CPU 10 automatically decides on related categories.

Also, when the user has selected the “current image quality state (detailed setting mode)” on the “image quality adjustment screen selection” screen shown in FIG. 8, the adjustment value of the contrast, which is a category related to “dazzling,” is obtained. For example, when the contrast has been adjusted to about 65 (can be selected from 0 to 100), the CPU 10 stores the adjustment value of 65 in the flash memory 12 as adjustment history. Based on this adjustment history, as shown in FIG. 10, the CPU 10 controls the adjustment amount such that the adjustment unit of the adjustment range is made smaller in the vicinity of 65, which is the adjustment value. This allows for fine adjustment of the contrast with respect to the image quality.

When the user has selected the batch adjustment mode on the “image quality adjustment screen selection” screen shown in FIG. 8, one image quality adjustment category 31, namely, “dazzling,” is displayed such that the backlight and the contrast, which are categories related to “dazzling,” can be adjusted collectively or together. Further, the user adjusts the image quality adjustment category 31 called “dazzling.” Consequently, the CPU 10 adjusts the image quality by adjusting the image quality adjustment categories 32 of the backlight and the contrast in conjunction with each other so as to correspond to the adjustment of “dazzling.”

Also, by selecting either backlight or contrast after adjustment of the image quality adjustment category 31 of “dazzling”, the CPU 10 can individually adjust either the backlight or the contrast without the two being adjusted in conjunction with each other.

When the user has selected the screen splitting adjustment mode on the “image quality adjustment screen selection” screen shown in FIG. 8, the user selects the image quality adjustment categories 32 shown in FIG. 9. The CPU 10 splits and displays the “image quality adjustment screen” on the display unit 11 according to the number of selected image quality adjustment categories 32, and selectively reflects the adjustment state of each of the selected image quality adjustment categories 32 on the corresponding split screens of the display unit 11. In this embodiment, a case is described in which two of the decided image quality adjustment categories 32 are selected by the user.

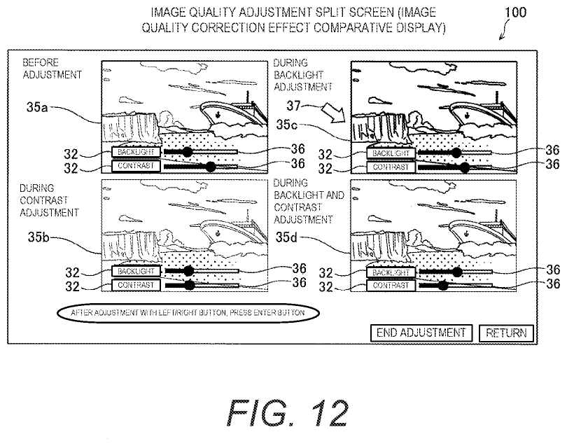

As shown in FIG. 12, when two image quality adjustment categories 32 are selected, the CPU 10 splits the screen into four split screens on the “image quality adjustment screen.” The screen from before adjustment is displayed as the upper left screen 35a. On the lower left screen 35b, only one of the image quality adjustment categories 32 can be adjusted (“contrast” in this embodiment). On the upper right screen 35c, only different one of the image quality adjustment categories 32 that is different from the one on the lower left screen 35b can be adjusted (“backlight” in this embodiment). On the lower right screen 35d, two image quality adjustment categories 32 can be adjusted (“backlight” and “contrast” in this embodiment).

The user operates the cursor 37 displayed on the display unit 11 by pressing the arrow button 25 (see FIG. 4). Consequently, the CPU 10 receives the user selection of the image quality adjustment category 32. The user can also press the arrow button 25 of the remote controller 17 to select an image quality adjustment category 32 from among three screens (the lower left screen 35b, upper right screen 35c, and lower right screen 35d). If the user moves the cursor 37 with respect to the image quality adjustment categories 32 and then presses the enter button 22, the CPU 10 receives the selection of the image quality adjustment category 32. As a result, the cursor 37 moves to an image quality adjustment bar 36 of the image quality adjustment category 32, and the user adjusts the image quality by pressing the arrow button 25 to the left or right. After adjusting the image quality, the user presses the enter button 22 to return the cursor 37 to a state in which other image quality adjustment categories 32 can be selected. The user then ends the screen adjustment by selecting end adjustment.

In addition to image quality adjustment, the CPU 10 adjusts the sound quality of the audio outputted from the audio output unit 18. The CPU 10 decides on, from among a plurality of sound quality adjustment categories 40, at least one sound quality adjustment category 40 related to user request for sound quality of the audio on the basis of user input operation related to the user request for the sound quality of the audio made on the remote controller 17, displays, the display unit 11, the decided sound quality adjustment category 40.

### Sound Quality Adjustment

Also, when the sound quality setting 39 is selected from the “video/audio setting” (see FIG. 5), the CPU 10 displays “sound quality setting” (see FIG. 12) on the display unit 11. The CPU 10 receives the input of a request about sound quality when the current sound quality state 41 is selected. For example, when “noise” is inputted, the CPU 10 is configured to decide on the equalizer, which is a sound quality adjustment category 40 related to “noise,” and display this on the display unit 11.

### Image Quality Adjustment Processing

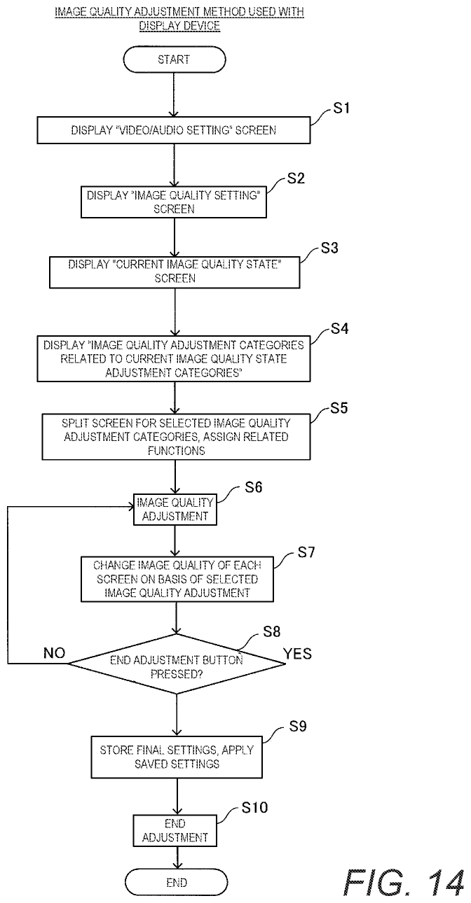

Next, the image quality adjustment processing flow of the display device 100 according to this embodiment will be described with reference to FIG. 14. In this flow, an example will be described in which the screen splitting adjustment mode is selected on the “image quality adjustment screen selection” screen (see FIG. 8). Processing in the display device 100 is performed by the CPU 10.

First, as shown in FIG. 14, in step 51, when the option button 21 (see FIG. 2) on the remote controller 17 is pressed, the CPU 10 displays the “video/audio setting” screen (see FIG. 5) on the display unit 11. The CPU 10 receives the selection of the image quality setting 38 from the categories of “video/audio setting” when the user operates the remote controller 17.

Next, in step S2, the CPU 10 displays the “image quality setting” screen (see FIG. 6) on the display unit 11. The CPU 10 proceeds to step S3 on the basis of the user selection of the current image quality state 34 from the categories of “image quality setting.”

Then, in step S3, the CPU 10 displays the “current image quality state” screen (see FIG. 7) on the display unit 11. The CPU 10 proceeds to step S4 on the basis of receipt of the user selection from among the options 33 of the adjustment categories of the current image quality state 34.

In step S4, the CPU 10 displays the “current image quality state (normal mode)” screen (see FIG. 9) on the display unit 11. The CPU 10 receives the selection of an image quality adjustment category 32 from among the “current image quality state (normal mode)” when the user operates the remote controller 17.

In step S5, the CPU 10 displays the “image quality adjustment screen” on the display unit 11, as shown in FIG. 12. Also, the CPU 10 splits the screen for the image quality adjustment categories 32 selected by the user and assigns related functions.

In step S6, the CPU 10 receives the image quality adjustment made by the user.

Next, in step S7, the CPU 10 changes the image quality of each screen on the basis of the user image quality adjustment.

Next, in step S8, the CPU 10 determines whether or not the end adjustment button has been pressed by the user. If the end adjustment button has not been pressed, the CPU 10 returns to step S6 to continue image quality adjustment. Once the end adjustment button is selected, the CPU 10 proceeds to step S9.

In step S9, the CPU 10 stores the final settings in the flash memory 12 and applies the saved settings to the image quality. Consequently, the CPU 10 displays the adjusted image quality on the display unit 11.

In step S10, the CPU 10 closes the adjustment screen and ends the image quality adjustment once the user operates the remote controller 17 to select end adjustment.

### EFFECT OF THIS EMBODIMENT

The following effect can be obtained with this embodiment.

In this embodiment, as described above, the display device 100 comprises the display unit 11 that displays the video, the CPU 10 that controls the image quality adjustment of the video displayed on the display unit 11, and the remote controller 17 that receives the user input related to the image quality of the video. The CPU 10 is configured to decide on at least one image quality adjustment category 32 related to the user input content from among the image quality adjustment categories 30, on the basis of the user input operation on the remote controller 17 related to the image quality of the video, and to display, on the display unit 11, the operation screen for the decided image quality adjustment category 32 so as to perform the image quality adjustment operation for the decided image quality adjustment category 32. Here, the CPU 10 automatically decides on the image quality adjustment category 32 related to the user input content from among the image quality adjustment categories 30 that are not familiar to a typical user, on the basis of the user input operation. With the above configuration, the user can input information related to the image quality that the user wants to adjust. Therefore, even if the user does not fully understand the image quality adjustment categories 32, the user can still adjust to the desired image quality using the image quality adjustment categories 32 decided on by the CPU 10. These categories make it easy to perform image quality adjustment that matches what the user intended.

Also, in this embodiment, as described above, the user input related to the image quality of the video includes the first input content indicating the user request for improvement of the image quality of the video, or the second input content indicating the user state. Consequently, the user can input an improvement request to address some issue that the user has with image quality, such as that the image is too bright, too dark, or too dazzling. It is also possible to input the user state of the user viewing the display device 100, such as being stressed or tired.

Also, in this embodiment, as described above, the remote controller 17 includes at least one of the character input unit 17a that receives character input and the microphone 17b that receives audio input to receive the user request for improvement of the image quality of the video indicated by the first input content, or the user state indicated by the second input content. Consequently, the user can easily input, by text or by voice, an improvement request to address some issue that the user has with image quality, such as that the image is too bright, too dark, or too dazzling, or the user state of the user when the user is stressed or tired. In particular, less voice input or text input is required of the user, thus saving time and effort for character input.

Also, in this embodiment, as described above, the CPU 10 is configured to display, on the display unit 11, the options 33 corresponding to the preset user requests for improvement of the image quality of the video. The controller is configured to display, on the display unit 11, the image quality adjustment categories 30 related to the user request for improvement of the image quality of the video so as to be able to perform the image quality adjustment operation for the image quality adjustment categories 30, on the basis of the user selection operation for the displayed option 33 corresponding to the user request for improvement of the image quality of the video. Consequently, even if the user finds it difficult to specifically express the image quality improvement request in text or by voice, the option 33 can still be selected from options 33 that are close to the user's feeling.

Also, in this embodiment, as described above, the CPU 10 is configured to decide on the image quality adjustment categories 32 on the basis of the user input operation related to the user request for improvement of the image quality of the video. The CPU 10 is configured to display, on the display unit 11, one image quality adjustment category 31 to adjust the image quality adjustment categories 32 together according to the adjustment of the one image quality adjustment category 31 in response to the user adjusting the one image quality adjustment category 31 displayed on the display unit. This eliminates the need for the user to individually adjust the image quality adjustment categories 32 decided on by the CPU 10. Therefore, the user can adjust the image quality more easily.

Also, in this embodiment, as described above, the CPU 10 is configured to receive the user selection of one of the image quality adjustment categories 32 after adjusting the one image quality adjustment category 31 so as to be able to individually perform the image quality adjustment operation for the selected one of the image quality adjustment categories 32. The CPU 10 is configured to prohibit adjustment of remainder of the image quality adjustment categories 32 other than the selected one of the image quality adjustment categories 32 while the selected one of the image quality adjustment categories 32 is being adjusted. As a result, if the user is still dissatisfied with the image quality after adjusting the image quality with the one image quality adjustment category 31, it is possible to individually adjust only the image quality adjustment category 32 that the user wants to adjust. Therefore, it is possible to adjust to the image quality desired by the user.

Also, in this embodiment, as described above, the CPU 10 is configured to decide on the at least one image quality adjustment category 32 related to text when the user state is inputted to the remote controller 17 as the text, and to display, on the display unit 11, the operation screen for the decided image quality adjustment category 32. Consequently, for example, merely by inputting a word such as stress, the CPU 10 decides on color temperature, which is an image quality adjustment category 32 for reducing stress, or the like as an image quality adjustment category 32. Consequently, since the CPU 10 decides on the at least one image quality adjustment category 32 related to the user state, the user does not have to search for an image quality adjustment category 30 related to the user state from among the image quality adjustment categories 30, so image quality can be easily adjusted as intended by the user.

Also, in this embodiment, as described above, the CPU 10 is configured to display, on the display unit 11, the split screens that have been split according to the number of the image quality adjustment categories 32 selected by the user. The CPU 10 is configured to selectively reflect the adjustment state for each of the image quality adjustment categories 32 selected by the user on corresponding one of the split screens of the display unit 11. Consequently, the image quality can be adjusted while comparing the change in image quality before and after the image quality adjustment. Accordingly, if the change in image quality before and after the image quality adjustment can be compared, the user can clearly evaluate whether or not the image quality has improved after the image quality adjustment.

Also, in this embodiment, as described above, the CPU 10 is configured to change the adjustment unit of the adjustment range of the adjustment amount on the basis of the user adjustment history for the image quality adjustment categories 32 in the image quality adjustment. The CPU 10 is configured to make the adjustment unit of the adjustment range smaller on the basis of the user adjustment history for the image quality adjustment categories 32 to more precisely perform the image quality adjustment than with the preset adjustment range. Consequently, the CPU 10 can make the adjustment unit smaller than with the preset adjustment range preset for the adjustment range that is frequently used by the user, on the basis of the user adjustment history of adjusting the image quality adjustment categories, thereby allowing more precise image quality adjustment than with the preset adjustment range.

Also, in this embodiment, as described above, the display device 100 further comprises the audio output unit 18 that outputs audio. The CPU 10 is configured to adjust the sound quality of the audio outputted from the audio output unit 18 in addition to the image quality adjustment. The CPU 10 is configured to decide on, from among a plurality of sound quality adjustment categories 40, the at least one sound quality adjustment category 40 related to the user request for sound quality of the audio on the basis of the user input operation related to the user request for sound quality of the audio to the remote controller 17, and to display, the display unit 11, the operation screen for the at least one sound quality adjustment category 40. Consequently, the user can input the user input content related to sound quality that the user wants to adjust. Also, the CPU 10 automatically decides on a sound quality adjustment category 40 related to what the user has inputted, on the basis of the user input content, from among the sound quality adjustment categories 40 that are unfamiliar to the typical user. Therefore, even if the user does not fully understand the sound quality adjustment categories 40, the user can adjust the sound quality as desired by using the sound quality adjustment categories 40 decided on by the CPU 10. These categories make it easy to perform sound quality adjustment that matches what the user intended.

### MODIFICATION EXAMPLES

The embodiment disclosed herein is just an example in every respect, and should not be interpreted as being limiting in nature. The scope of the invention being indicated by the appended claims rather than by the above description of the embodiments, all modifications (modification examples) within the meaning and range of equivalency of the claims are included.

In the above embodiment, an example is given in which the character input units 17a are arranged in the order of the Japanese syllabary, but the present invention is not limited to this. In the present invention, the character input units 17a may be arranged as on the keyboard of a personal computer.

In the above embodiment, an example is given in which operating the display device 100 is operated with the remote controller 17 that came with the display device 100, but the present invention is not limited to this. In the present invention, the display device 100 may be operated by using a portable terminal such as a mobile phone instead of the remote controller 17 that comes with the display device 100.

In the above embodiment, an example is given in which “dazzling” is selected as the option 33 in the category of the current image quality state 34, but the present invention is not limited to this. In the present invention, the user state, such as stressed, may be selected as an option 33 in the category of the current image quality state 34.

In the above embodiment, an example is given in which “dazzling” is selected as the option 33 in the category of the current image quality state 34, but the present invention is not limited to this. In the present invention, a word or phrase may be inputted by character input or audio/voice input instead of the option 33 in the category of the current image quality state 34.

In the above embodiment, an example is given in which the image quality adjustment screen is split into four, but the present invention is not limited to this. In the present invention, the image quality adjustment screen may instead be split in two.

In the above embodiment, an example is given in which the image quality adjustment screen is split into four, but the present invention is not limited to this. In the present invention, the image quality adjustment screen may be such that the screens before and after adjustment change periodically so that the screen adjustment screens can be compared.

In view of the state of the known technology, a display device according to one aspect of the present disclosure comprises a display that displays video, a controller that controls image quality adjustment of the video displayed on the display, and a user interface that receives user input related to image quality of the video. The controller is configured to decide on, from among a plurality of image quality adjustment categories, at least one image quality adjustment category related to user input content, on the basis of user input operation related to the image quality of the video to the user interface, and to display, on the display, an operation screen for the at least one image quality adjustment category so as to perform an image quality adjustment operation for the at least one image quality adjustment category.

With the display device according to the one aspect of the present disclosure, as described above, the controller is configured to decide on, from among the image quality adjustment categories, the at least one image quality adjustment category related to the user input content, on the basis of the user input operation related to the image quality of the video to the user interface, and to display, on the display, the operation screen for the at least one image quality adjustment category so as to perform the image quality adjustment operation for the at least one image quality adjustment category. Here, the controller automatically decides on the at least one image quality adjustment category related to the user input content, on the basis of the user input operation, from among the image quality adjustment categories that are unfamiliar to the typical user. With the above configuration, information about the image quality that the user wants to adjust can be inputted. Therefore, even if the user does not fully understand the image quality adjustment categories, the user can still adjust to the desired image quality by using the image quality adjustment categories decided on by the controller. These categories make it easy to perform the image quality adjustment that matches what the user intended.

In accordance with a preferred embodiment according to the display device mentioned above, the user input related to the image quality of the video includes first input content indicating user request for improvement of the image quality of the video, or second input content indicating user state. With this configuration, the user can input an improvement request to adjust the user's dissatisfaction with image quality, such as brightness, darkness, or glare. It is also possible to input the user state of the user who is looking at the display device, such as being stressed or tired.

In accordance with a preferred embodiment according to any one of the display devices mentioned above, the user interface includes at least one of a character input interface that receives character input and an audio input interface that receives audio input to receive the user request for improvement of the image quality of the video indicated by the first input content, or the user state indicated by the second input content. With this configuration, the user can easily input, by voice or text, an improvement request to adjust the user's dissatisfaction with image quality, such as brightness, darkness, or glare, and the user state, such as being stressed or tired. In particular, this means that the user does not have to input as much by voice or text, so the trouble of having to input text can be eliminated.

In accordance with a preferred embodiment according to any one of the display devices mentioned above, the controller is configured to display, on the display, options corresponding to preset user requests for improvement of the image quality of the video. The controller is configured to display, on the display, the at least one image quality adjustment category related to the user request for improvement of the image quality of the video so as to be able to perform the image quality adjustment operation for the at least one image quality adjustment category, on the basis of the user selection operation for one of the displayed options corresponding to the user request for improvement of the image quality of the video. With this configuration, even if the user finds it difficult to specifically express the improvement request for the image quality in text or voice, it is possible to select an option that is close to what the user is feeling.

In accordance with a preferred embodiment according to any one of the display devices mentioned above, the controller is configured to decide on a set of the image quality adjustment categories on the basis of the user input operation related to the user request for improvement of the image quality of the video. The controller is configured to display, on the display, one image quality adjustment category to adjust the decided set of the image quality adjustment categories together. The controller is configured to adjust the decided set of the image quality adjustment categories together according to adjustment of the one image quality adjustment category in response to the user adjusting the one image quality adjustment category displayed on the display. With this configuration, the user does not need to individually adjust the image quality adjustment categories decided on by the controller. Therefore, the user can adjust image quality more easily.

In accordance with a preferred embodiment according to any one of the display devices mentioned above, the controller is configured to receive user selection of one of the decided set of the image quality adjustment categories after adjusting the one image quality adjustment category so as to be able to individually perform the image quality adjustment operation for the selected one of the decided set of the image quality adjustment categories. The controller is configured to prohibit adjustment of remainder of the decided set of the image quality adjustment categories other than the selected one of the decided set of the image quality adjustment categories while the selected one of the decided set of the image quality adjustment categories is being adjusted. With this configuration, if the user is still dissatisfied with the image quality after adjusting the image quality with the one image quality adjustment category, it is possible to individually adjust only the image quality adjustment category that the user wants to adjust. Therefore, the user can adjust to the desired image quality.

In accordance with a preferred embodiment according to any one of the display devices mentioned above, the controller is configured to decide on the at least one image quality adjustment category related to text when the user state is inputted to the character input interface as the text, and to display, on the display, the operation screen for the at least one image quality adjustment category. With this configuration, for example, merely by inputting a word such as stress, the controller decides on color temperature, which is an image quality adjustment category for reducing stress, or the like as an image quality adjustment category. Consequently, since the controller decides on an image quality adjustment category related to the user state, the user does not have to search for an image quality adjustment category related to the user state from among the image quality adjustment categories, so image quality can be easily adjusted as intended by the user. Incidentally, color temperature is an index of the color of light emitted by a light source, such as sunlight or natural light, or artificial lighting, and the lower is the color temperature, the warmer is the color. Also, the higher is the color temperature, the cooler is the color.

In accordance with a preferred embodiment according to any one of the display devices mentioned above, the controller is configured to display, on the display, split screens that have been split according to the number of the image quality adjustment categories selected by the user. The controller is configured to selectively reflect adjustment state for each of the image quality adjustment categories selected by the user on corresponding one of the split screens of the display. With this configuration, the image quality can be adjusted while comparing the change in image quality before and after the image quality adjustment. Accordingly, if the change in image quality before and after the image quality adjustment can be compared, the user can clearly evaluate whether or not the image quality has improved after the image quality adjustment.

In accordance with a preferred embodiment according to any one of the display devices mentioned above, the controller is configured to change an adjustment unit of an adjustment range of an adjustment amount on the basis of user adjustment history for the image quality adjustment categories in the image quality adjustment. The controller is configured to make the adjustment unit of the adjustment range smaller on the basis of the user adjustment history for the image quality adjustment categories to more precisely perform the image quality adjustment than with a preset adjustment range. With this configuration, the controller can make the adjustment unit smaller than with the preset adjustment range preset for the adjustment range that is frequently used by the user, on the basis of the user adjustment history of adjusting the image quality adjustment categories, thereby allowing more precise image quality adjustment than with the preset adjustment range.

In accordance with a preferred embodiment according to any one of the display devices mentioned above, the display device further comprises an audio output unit that outputs audio. The controller is configured to adjust sound quality of the audio outputted from the audio output unit in addition to the image quality adjustment. The controller is configured to decide on, from among a plurality of sound quality adjustment categories, at least one sound quality adjustment category related to user request for sound quality of the audio on the basis of user input operation related to the user request for sound quality of the audio to the user interface, and to display, on the display, operation screen for the at least one sound quality adjustment category. With this configuration, the user can input user input content related to sound quality that the user wants to adjust. Also, the controller automatically decides on the at least one sound quality adjustment category related to what the user has inputted, on the basis of the user input content, from among the sound quality adjustment categories that are unfamiliar to the typical user. Therefore, even if the user does not fully understand the sound quality adjustment categories, the user can adjust the sound quality as desired by using the sound quality adjustment categories decided on by the controller. These categories make it easy to perform sound quality adjustment that matches what the user intended.

With the present disclosure, a display device can be provided with which the image quality adjustment intended by a user can be easily performed.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a display device in an upright position on a horizontal surface. Accordingly, these directional terms, as utilized to describe the display device should be interpreted relative to a display device on a horizontal surface. The terms “left” and “right” are used to indicate the “right” when referencing from the right side as viewed from the front side of the display device, and the “left” when referencing from the left side as viewed from the front side of the display device.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A display device comprising:
a display configured to display video;
a controller configured to control image quality adjustment of the video displayed on the display; and
a user interface configured to receive user input related to image quality of the video,
the controller being configured
to decide on, from among a plurality of image quality adjustment categories, at least one image quality adjustment category related to user input content, on the basis of user input operation related to the image quality of the video to the user interface, and
to display, on the display, an operation screen for the at least one image quality adjustment category so as to perform an image quality adjustment operation for the at least one image quality adjustment category.

2. The display device according to claim 1, wherein
the user input related to the image quality of the video includes first input content indicating user request for improvement of the image quality of the video, or second input content indicating user state.

3. The display device according to claim 2, wherein
the user interface includes at least one of a character input interface that is configured to receive character input and an audio input interface that is configured to receive audio input to receive the user request for improvement of the image quality of the video indicated by the first input content, or the user state indicated by the second input content.

4. The display device according to claim 2, wherein
the controller is configured to display, on the display, options corresponding to preset user requests for improvement of the image quality of the video.

5. The display device according to claim 4, wherein
the controller is configured to display, on the display, the at least one image quality adjustment category related to the user request for improvement of the image quality of the video so as to be able to perform the image quality adjustment operation for the at least one image quality adjustment category, on the basis of user selection operation for one of the displayed options corresponding to the user request for improvement of the image quality of the video.

6. The display device according to claim 1, wherein
the controller is configured to decide on a set of the image quality adjustment categories on the basis of the user input operation related to the user request for improvement of the image quality of the video.

7. The display device according to claim 6, wherein
the controller is configured to display, on the display, one image quality adjustment category to adjust the decided set of the image quality adjustment categories together.

8. The display device according to claim 7, wherein
the controller is configured to adjust the decided set of the image quality adjustment categories together according to adjustment of the one image quality adjustment category in response to the user adjusting the one image quality adjustment category displayed on the display.

9. The display device according to claim 8, wherein
the controller is configured to receive user selection of one of the decided set of the image quality adjustment categories after adjusting the one image quality adjustment category so as to be able to individually perform the image quality adjustment operation for the selected one of the decided set of the image quality adjustment categories.

10. The display device according to claim 9, wherein
the controller is configured to prohibit adjustment of reminder of the decided set of the image quality adjustment categories other than the selected one of the decided set of the image quality adjustment categories while the selected one of the decided set of the image quality adjustment categories is being adjusted.

11. The display device according to claim 3, wherein
the controller is configured to decide on the at least one image quality adjustment category related to text when the user state is inputted to the character input interface as the text, and to display, on the display, the operation screen for the at least one image quality adjustment category.

12. The display device according to claim 1, wherein
the controller is configured to display, on the display, split screens that have been split according to the number of the image quality adjustment categories selected by the user.

13. The display device according to claim 12, wherein
the controller is configured to selectively reflect adjustment state for each of the image quality adjustment categories selected by the user on corresponding one of the split screens of the display.

14. The display device according to claim 1, wherein
the controller is configured to change an adjustment unit of an adjustment range of an adjustment amount on the basis of user adjustment history for the image quality adjustment categories in the image quality adjustment.

15. The display device according to claim 14, wherein
the controller is configured to make the adjustment unit of the adjustment range smaller on the basis of the user adjustment history for the image quality adjustment categories to more precisely perform the image quality adjustment than with a preset adjustment range.

16. The display device according to claim 1, further comprising
an audio output unit configured to output audio.

17. The display device according to claim 16, wherein
the controller is configured to adjust sound quality of the audio outputted from the audio output unit in addition to the image quality adjustment.

18. The display device according to claim 16, wherein
the controller is configured
to decide on, from among a plurality of sound quality adjustment categories, at least one sound quality adjustment category related to user request for sound quality of the audio on the basis of user input operation related to the user request for sound quality of the audio to the user interface, and
to display, on the display, operation screen for the at least one sound quality adjustment category.

19. The display device according to claim 3, wherein
the character input interface includes a remote controller, and
the audio input interface includes a microphone.

20. The display device according to claim 16, wherein
the audio output unit includes a speaker.
